(19) United States
(12) Patent Application Publication
(10) Pub. No.: US 2005/0244654 A1
(43) Pub. Date: Nov. 3, 2005

(54) Artificial leather

(75) Inventors: Ching-Tang Wang, Taipei (TW); Mong-Ching Lin, Kaohsiung (TW); Chung-Chih Feng, Kaohsiung (TW); Jung-Ching Chang, Kaohsiung (TW); Hsien-Chang Hung, Kaohsiung (TW); Ping-Liang Chiu, Pyngdong Shiann (TW); Chien-Te Wu, Pyngdong Shiann (TW)

Correspondence Address: NIKOLAI & MERSEREAU, P.A., 900 SECOND AVENUE SOUTH, SUITE 820, MINNEAPOLIS, MN, 55402, US

(73) Assignee: San Fang Chemical Industry Co. LTD., Kaohsiung (TW)

(21) Appl. No.: 10/838,728

(22) Filed: May 3, 2004

(51) Int. Cl. B32B 27/00

(52) U.S. Cl. 428/423.1

(57) ABSTRACT

Artificial leather includes a substrate, a coating of a single type of elastomeric resin provided on the substrate and particles of the single type of elastomeric resin evenly spread into the substrate from the coating. The density of the substrate filled with the particles is greater than that of the coating.

### FIELD OF INVENTION

The present invention relates to artificial leather and production of such artificial leather.

### BACKGROUND OF INVENTION

Artificial leather comprises a layer of cloth (“substrate”) and a layer of elastomeric resin (“coating”) formed on the substrate. Generally, the substrate is a layer of non-woven cloth. To provide an integral look, the substrate must be dyed and the hue of the substrate must be identical to that of the coating.

To this end, two processes have been taken for production of artificial leather. In the first process, the substrate is submerged in a first type of elastomeric resin of a color so that the substrate is dyed. Then, in a pre-curing step, the first type of elastomeric resin absorbed by means of the substrate is cured. After the pre-curing step, the substrate is coated with a second type of elastomeric resin. Compared with the first type of elastomeric resin, the second type of elastomeric resin includes a high solid content. The second type of elastomeric resin is of the same color as the first type of elastomeric resin. Then, the coating is cured. After that, the artificial leather is washed and dried. The second process is identical to the first process except for saving the pre-curing step. In other words, the substrate is coated with the second type of elastomeric resin when the substrate is still wet from the first type of elastomeric resin.

FIG. 2 shows artificial leather 100 made according to the first process. The artificial leather 100 includes a substrate 102, a coating 104 of the second type of elastomeric resin and particles 106 of the first type of elastomeric resin filled in the substrate 102. Because of the pre-curing step, the particles 106 of the first type of elastomeric resin are evenly scattered in the substrate 102 on one hand. On the other hand, moisture exists on the surface of the substrate 102. The moisture dissolves an amount of the second type of elastomeric resin when the substrate 102 is coated with the second type of elastomeric resin. This amount of the second type of elastomeric resin dissolved in the moisture eventually forms a dense layer 108. The dense layer 108 provides an un-desirable laminate look to the artificial leather 100.

FIG. 3 shows artificial leather 200 made according to the second process. The artificial leather 200 includes a substrate 202, a coating 204, particles of a first type of elastomeric resin 208. The substrate 202 is submerged in the first type of elastomeric resin. The first type of elastomeric resin will eventually cure and become the particles 208. Before the first type of elastomeric resin cures, the substrate 202 is coated with the second type of elastomeric resin. The second type of elastomeric resin will eventually cure and become the coating 204. Without undertaking the pre-curing step, no dense layer occurs in the artificial leather 200. However, when coated with the second type of elastomeric resin, the substrate 202 absorbs an amount of the second type of elastomeric resin. This amount of the second type of elastomeric resin reaches an area near the interface between the substrate 202 and the coating 204. In this area of the substrate 202, the second type of elastomeric resin cures and becomes particles 206. The uneven presence is not desirable.

In the first or second process, two types of elastomeric resin are used, and this entails high costs in materials, requires many steps in the production and elongates the production. The problem of the high costs in the materials is worsen by residue of the first type of elastomeric resin in a container in which the substrate is submerged in the first type of elastomeric resin.

There is another process particularly, if not only, useful in making artificial leather including a thin substrate such as those made of RAYON. In this process, the substrate is coated with only one type of elastomeric resin without being previously submerged in another type of elastomeric resin. The elastomeric resin is supposed to spread in the substrate. It is however difficult for the elastomeric resin to spread evenly in the substrate. Therefore, this process is limited to the production of artificial leather including a substrate less than 0.5 mm thick. Artificial leather so made cannot be used to make shoes except for insoles. In addition, the coating can easily detached or peeled from the substrate.

The present invention is therefore intended to obviate or at least alleviate the problems encountered in prior art.

### SUMMARY OF INVENTION

It is an objective of the present invention to provide artificial leather including a substrate and a coating that look integral.

It is another objective of the present invention to provide artificial leather including a substrate and a coating that firmly sticks to the substrate.

According to the present invention, artificial leather includes a substrate, a coating of a single type of elastomeric resin provided on the substrate and particles of the single type of elastomeric resin evenly spread into the substrate from the coating. The density of the substrate filled with the particles is greater than that of the coating.

Other objects, advantages and novel features of the invention will become more apparent from the following detailed description in conjunction with the attached drawings.

### BRIEF DESCRIPTION OF DRAWINGS

The present invention will be described via detailed illustration of some preferred embodiment referring to the drawings.

FIG. 1 is a cross-sectional view of artificial leather according to the present invention.

FIG. 2 is a cross-sectional view of a first conventional type of artificial leather.

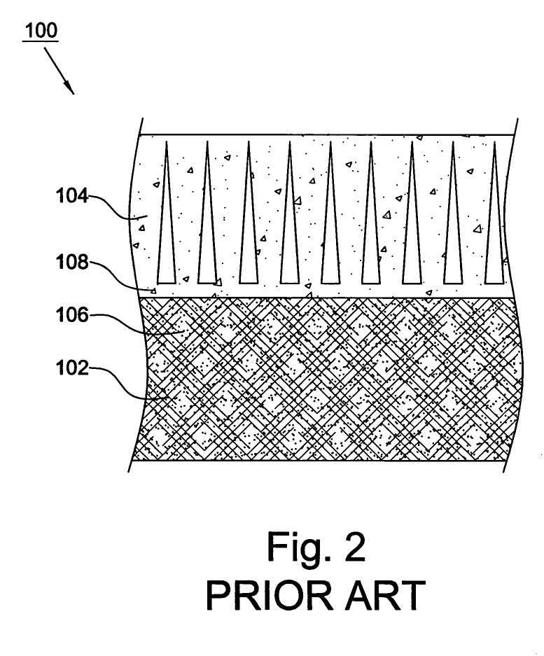

FIG. 3 is a cross-sectional view of a second conventional type of artificial leather.

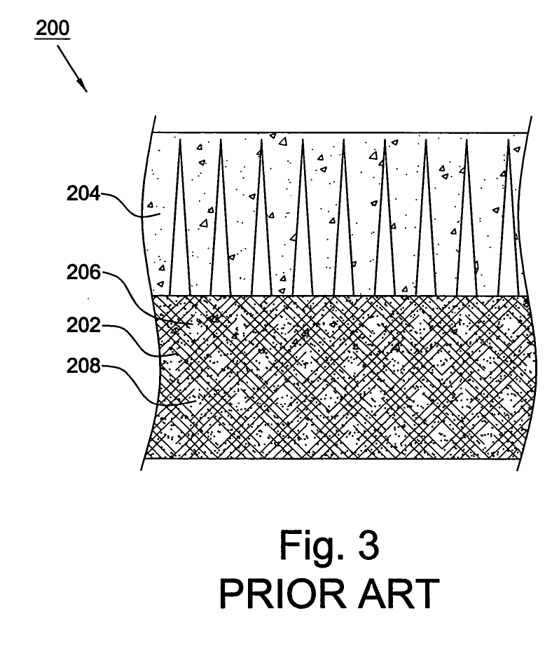

### DETAILED DESCRIPTION OF EMBODIMENTS

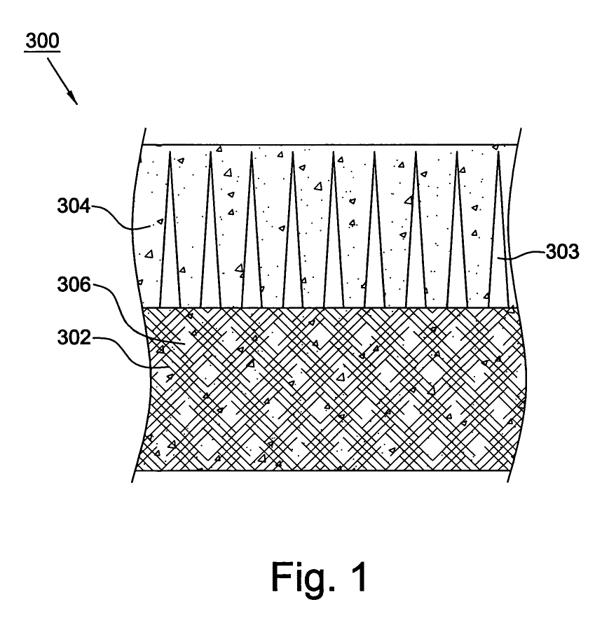

Referring to FIG. 1, according to the present invention, artificial leather 300 includes a layer 302 of cloth (“substrate”), a layer 304 of a single type of elastomeric resin (“coating”) and particles 306 of the single type of elastomeric resin scattered evenly in the substrate 302. A method for production of the artificial leather 300 will be described.

Firstly, the substrate 302 is provided. The substrate 302 is preferably non-woven cloth with a thickness of 0.5-2.2 mm and a specific weight of 70-600 g/m². The substrate 302 may be submerged in silicone polymer with surface-active agent of anion and water-soluble resin such as water-soluble acrylic and polyvinyl alcohol (“PVA”). Thus, the substrate 302 can better stick to the coating 304.

Then, the substrate 302 is coated with the single type of elastomeric resin. The single type of elastomeric resin is one-component polyurethane, styrene butadiene rubber (“SBR”), nitrile butadiene rubber (“NBR”), polyamide or acrylic. One-component polyurethane is preferred. Now, the single type of elastomeric resin is in the form of liquid so as to permeate the substrate 302 from an upper surface towards a lower surface because of gravity.

However, the gravity alone cannot scatter the single type of elastomeric resin sufficiently and evenly in the substrate 302 particularly when the substrate 302 is thick. Hence, an additional step is taken in order to enhance the infiltration of the single type of elastomeric resin into the substrate 302. Taken properly, the infiltration-enhancing step can ensure that the single type of elastomeric resin evenly permeates into the substrate 302.

The infiltration-enhancing step may be taken via performing vacuum on the lower surface of the substrate 302. Thus, the air pressure on the upper surface of the substrate 302 is less than the air pressure on the lower surface of the substrate 302. Thanks to the pressure difference between the upper and lower surfaces of the substrate 302, the infiltration rate of the elastomeric resin is increased.

Then, the single of elastomeric resin coated on the substrate 302 is cured.

Finally, the artificial leather is washed and dried.

After the artificial leather is washed and dried, the coating 304 may additionally be printed with natural textures through releasing paper or by means of embossing. Alternatively, the coating 304 may be grinded so as to provide a look imitative of chamois.

In a process according to a first embodiment of the present invention, the substrate 302 is non-woven cloth made of polyethylene terephthalate (“PET”), nylon, and other fibers that are mixed at different ratio. Further, the substrate 302 has a thickness of 0.9 mm and a specific weight of 200 g/m². The coating 304 is a layer of PU resin with a solid content of 20%. The coating 304 is 2.2 mm thick. Vacuum is provided on the lower surface of the substrate 302. The vacuum causes a pressure difference of 228 torr between the upper and lower surfaces of the substrate 302. The substrate 302 coated with the single type of elastomeric resin is submerged in a 15:85 mixture of dimethyl foramide (“DMF”) with water for 15 minutes, washed in water of 60 Celsius degrees for 60 minutes and dried in air of 140 Celsius degrees for 20 minutes. The anti-peeling strength of the artificial leather 300 is at least 3.2 kg/cm. The density of the coating 304 is 0.34 g/cm³. The density of the substrate 302 filled with the particles 306 is 0.38 g/cm³. After the artificial leather is washed and dried, the coating 304 may additionally be printed with natural textures through releasing paper or by means of embossing. Alternatively, the coating 304 may be grinded so as to provide a look imitative of chamois.

In a process according to a second embodiment of the present invention, the substrate 302 includes a thickness of 0.8 mm and a specific weight of 240 g/m². The substrate 302 is submerged in a mixture containing 95% of water, 1% of silicone polymer and 4% of water-dissolvent resin. The coating 304 is a layer of PU resin with a solid content of 20%. The coating 304 is 2.2 mm thick. Vacuum is provided on the lower surface of the substrate 302. The vacuum causes a pressure difference of 300 torr between the upper and lower surfaces of the substrate 302. The substrate 302 coated with the single type of elastomeric resin is submerged in a 15:85 mixture of DMF with water for 15 minutes, washed in water of 60 Celsius degrees for 60 minutes and dried in air of 140 Celsius degrees for 20 minutes. The anti-peeling strength of the artificial leather 300 is at least 3.5 kg/cm. The density of the coating 304 is 0.30 g/cm³. The density of the substrate 302 filled with the particles 306 is 0.45 g/cm³. After the artificial leather is washed and dried, the coating 304 may additionally be printed with natural textures through releasing paper or by means of embossing. Alternatively, the coating 304 may be grinded so as to provide a look imitative of chamois.

The present invention has been described via detailed illustration of the preferred embodiment. Those skilled in the art can derive variations from the preferred embodiment without departing from the scope of the present invention. Therefore, the preferred embodiment shall not limit the scope of the present invention defined in the claims.

1. Artificial leather comprising a substrate, a coating of a single type of elastomeric resin provided on the substrate and particles of the single type of elastomeric resin evenly spread into the substrate from the coating, the density of the substrate filled with the particles being greater than that of the coating.

2. The artificial leather according to claim 1 wherein the substrate is one of non-woven cloth and woven cloth.

3. The artificial leather according to claim 1 wherein the substrate comprises a thickness of 0.5-2.2 mm.

4. The artificial leather according to claim 1 wherein the substrate comprises a specific weight of 70-600 g/m².

5. The artificial leather according to claim 1 wherein the substrate is submerged in a mixture of water, silicone polymer and water-dissolvent resin before the coating is provided on the substrate.

6. The artificial leather according to claim 1 wherein the single type of elastomeric resin is one of one-component polyurethane, SBR, NBR, polyamide and acrylic.

7. A method for producing artificial leather comprising the steps of:
providing a substrate with an upper surface and a lower surface;
providing a coating of a single type of elastomeric resin on the upper surface of the substrate; and
providing a pressure difference between the upper and lower surfaces of the substrate so as to cause infiltration of the single type of elastomeric resin into the substrate from the upper surface to the lower surface.

8. The method according to claim 7 wherein the pressure difference is about 1-760 torr.

9. The method according to claim 7 wherein the step of providing the pressure difference is caused by means of providing vacuum on the lower surface of the substrate.

10. The method according to claim 7 comprising a step of submerging the substrate in a mixture of silicone polymer and water-soluble resin before the step of providing the coating on the substrate.

11. The method according to claim 7 comprising a step of printing the coating with natural textures.

12. The method according to claim 7 comprising a step of grinding the coating so as to provide a look imitative of chamois.

13. The method according to claim 7 wherein the density of the substrate filled with the particles is greater than that of the coating.

14. The method according to claim 7 wherein the substrate is one of non-woven cloth and woven cloth.

15. The method according to claim 7 wherein the substrate comprises a thickness of 0.5-2.2 mm.

16. The method according to claim 7 wherein the substrate comprises a specific weight of 70-600 g/m².

17. The method according to claim 7 wherein the single type of elastomeric resin is one of one-component polyurethane, SBR, NBR, polyamide and acrylic.
